(19) United States
(12) Patent Application Publication
(10) Pub. No.: US 2018/0004368 A1
(43) Pub. Date: Jan. 4, 2018

(54) INFORMATION PROCESSING APPARATUS

(71) Applicant: CASIO COMPUTER CO., LTD., Tokyo (JP)

(72) Inventor: Koji NISHITANI, Tokyo (JP)

(73) Assignee: CASIO COMPUTER CO., LTD., Tokyo (JP)

(21) Appl. No.: 15/467,816

(22) Filed: Mar. 23, 2017

(30) Foreign Application Priority Data
Jun. 30, 2016 (JP) 2016-129879

(51) Int. Cl. G06F 3/0482; G06F 17/30; G06Q 10/06; G06F 17/24

(52) U.S. Cl. CPC G06F 3/0482; G06Q 10/06311; G06F 17/30601; G06F 17/245

(57) ABSTRACT

An information processing apparatus according to an embodiment of the present invention includes: a first display control unit configured to display a list of tasks associated with attribute information, for each classification method in classifying the tasks into groups, the attribute information corresponding to the classification methods; and a second display control unit configured to extract, when any task in the list displayed by the first display control unit has been selected and any of the classification methods has been selected, a task having attribute information corresponding to the classification method that has been selected, similar to the attribute information of the task that has been selected, from the list, the second display control unit configured to display the task that has been extracted.

### CROSS-REFERENCE TO RELATED APPLICATIONS

This application is based upon and claims the benefit of priority from the prior Japanese Patent Application No. 2016-129879, filed Jun. 30, 2016, and the entire contents of which are incorporated herein by reference.

### BACKGROUND OF THE INVENTION

### 1. Field of the Invention

The present invention relates to an information processing apparatus.

### 2. Description of the Related Art

Conventionally, TODO list management has been known that makes and manages a list of tasks to be implemented by a predetermined deadline, such as today, (a TODO list). In the TODO list management, for example, a user writes a list of tasks in a personal organizer so as to generate and manage the list.

An application program has been known that is installed onto a portable terminal, registers tasks to be implemented, and displays a list of the tasks. For example, an application program has been known that associates tasks with implementation sites so as to make registration, acquires a current location regularly or at set time, displays a task having an implementation site in a predetermined distance from the current location, and then notifies a user (refer to JP 2015-8537 A).

### SUMMARY OF THE INVENTION

However, with the conventional application program, when a plurality of the tasks in low association with the current location, such as a task that can be implemented at close range with respect to a site accompanied with a long-distance transfer, or a task that can be implemented with common preparations or accessories, is efficiently implemented, the user is required to make a judgement in consideration so that the burden thereof is large.

An object of the present invention is to notify a user of the combination of tasks that can be efficiently implemented.

An information processing apparatus according to a first aspect of the present invention, includes: a first display control unit configured to display a list of tasks associated with attribute information, for each classification method in classifying the tasks into groups, the attribute information corresponding to the classification methods; and a second display control unit configured to extract, and display, from the list, when any task in the list displayed by the first display control unit has been selected and any of the classification methods has been selected, a task having attribute information corresponding to the classification method that has been selected, similar to the attribute information of the task that has been selected.

An information processing apparatus according to a second aspect of the present invention, includes: a task table including tasks managed with various types of attribute information; and a task extracting unit configured to refer to the task table, when a task to be implemented is selected, and to extract, as an individually-grouped task, a task having a specific type of the attribute information similar to the specific type of the attribute information of the task that has been selected.

An information processing apparatus according to a third aspect of the present invention, includes: a task table including tasks having determined reference implementation time, managed with various types of attribute information; a task extracting unit configured to refer to the task table, when a task to be implemented is selected, and to extract, as an individually-grouped task, a task having a specific type of the attribute information similar to the specific type of the attribute information of the task that has been selected; and an implementation schedule creating unit configured to combine, based on the reference implementation time of the task that has been selected and the reference implementation time of the individually-grouped task that has been extracted, at least one of the individually-grouped tasks with the task that has been selected so as to create implementation schedules over a predetermined period.

According to the aspects of the present invention, a user can be notified of the combination of tasks that can be efficiently implemented.

### BRIEF DESCRIPTION OF THE DRAWINGS

FIG. 1 is a block diagram of a schematic configuration of a task management system according to an embodiment of the present invention;

FIG. 2 is a block diagram of a functional configuration of a server;

FIG. 3 is a block diagram of a functional configuration of a terminal device;

FIG. 4 is a table of a data structure of a task table;

FIG. 5 is a table of a data structure of a task classification table;

FIG. 6 is a table of a data structure of an external site table;

FIG. 7 is a table of a data structure of an in-house site table;

FIG. 8 is a table of a data structure of an employee address table;

FIG. 9 is a table of a data structure of a schedule condition table;

FIG. 10 is a flow chart of implementation scheduled task determination processing;

FIG. 11 is a flow chart of individually-grouped task extraction processing;

FIG. 12 is a flow chart of implementation-schedule-creation attempt processing;

FIG. 13 is a view of an exemplary screen display of a task list;

FIG. 14A is a view of an exemplary screen display of an individually-grouped task (deadline priority) and FIG. 14B is a view of an exemplary screen display of implementation schedules (deadline priority extraction);

FIG. 15A is a view of an exemplary screen display of an individually-grouped task (site priority) and FIG. 15B is a view of an exemplary screen display of implementation schedules (site priority extraction);

FIG. 16 is an explanatory diagram of a site priority route in the implementation schedules created in accordance with the site priority;

FIG. 17 A is a view of exemplary screen display of an individually-grouped task (classification priority), and FIG. 17B is a view of an exemplary screen display of implementation schedules (classification priority extraction);

FIG. 18 is an explanatory diagram of a classification priority route of the implementation schedules created in accordance with the classification priority; and

FIG. 19 is a table of exemplary implementation schedules in disagreement with schedule conditions.

### DETAILED DESCRIPTION OF THE PREFERRED EMBODIMENTS

An embodiment of the present invention will be described in detail with reference to the attached drawings. Note that, the embodiment of the present invention is not limited to illustrated examples.

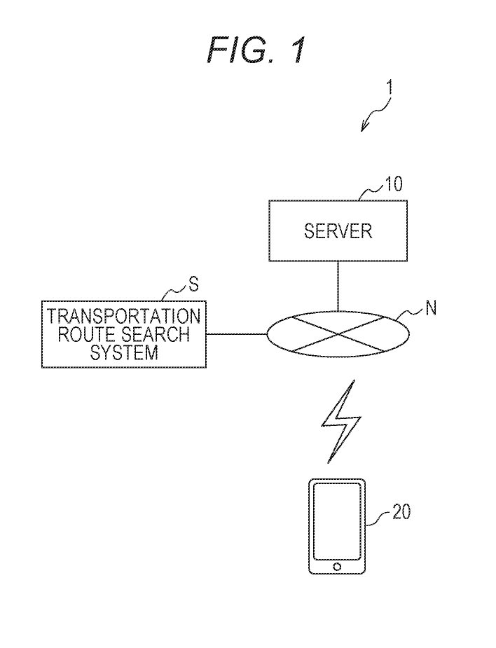

A configuration of an apparatus according to the present embodiment will be described with reference to FIGS. 1 to 3. A task management system 1 according to the present embodiment will be described with reference to FIG. 1. FIG. 1 is a block diagram of a schematic configuration of the task management system 1 according to the present embodiment.

The task management system 1 includes a server 10 and a terminal device 20. The server 10 is coupled to a communication network N, and manages information on tasks being task items implemented by a user of the terminal device 20. The communication network N is regarded as the Internet, but may be another network, such as a local area network (LAN).

The terminal device 20 is a portable terminal device to be carried with the user, such as a salesperson or serviceperson belonging to a corporation. Here, the terminal device 20 regarded as a tablet terminal will be described, but is not limited to this. The terminal device 20 may be another portable terminal device, such as a smartphone, a tablet personal computer (PC), a portable phone, a personal digital assistant (PDA), or a laptop PC. The terminal device 20 displays tasks to be implemented by the user, in a predetermined format on a screen. The terminal device 20 is coupled to the communication network N through a base station or a wireless LAN router (both not illustrated) on the communication network N.

A transportation route search system S is an existing information service coupled to the communication network N. Information indicating an origin and a terminal when a transfer is made by walk and public transportation (e.g., positional information, such as latitudes and longitudes), is transmitted to the transportation route search system S so that information including a transferring route between the origin, a relay, and the terminal, together with arrival/departure time at each of the origin, the relay, and the terminal, can be received as a response.

Note that, the task management system 1 has a configuration including the server 10 that manages task information on the user of one unit of the terminal device 20, but is not limited to this. The task management system 1 may include a plurality of the terminal devices 20 and the server 10 may integrally manage task information on each user of the plurality of the terminal devices 20.

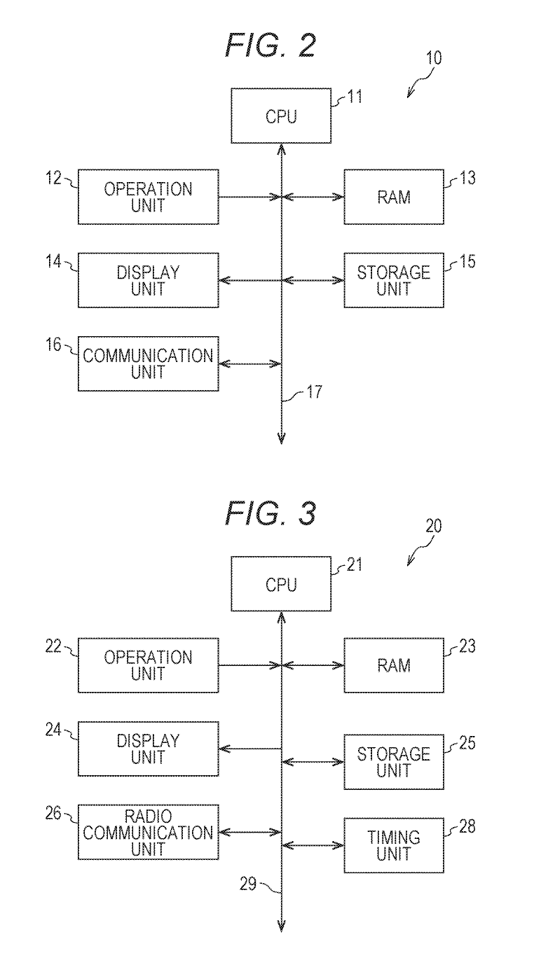

A functional configuration inside the server 10 will be described with reference to FIG. 2. FIG. 2 is a block diagram of the functional configuration of the server 10.

As illustrated in FIG. 2, the server 10 includes a central processing unit (CPU) 11, an operation unit 12, a random access memory (RAM) 13, a display unit 14, a storage unit 15 as a storing unit, and a communication unit 16. Each of the units in the server 10 is coupled through a bus 17.

The CPU 11 controls each of the units in the server 10. The CPU 11 reads a program specified from a system program and an application program stored in the storage unit 15, expands the program into the RAM 13, and performs various types of processing in cooperation with the program. The CPU 11 functions as a task extracting unit and an implementation-schedule-creating unit.

The operation unit 12 has a key input unit, such as a keyboard, and a pointing device, such as a mouse, receives key input and position input, and outputs the operation information thereof to the CPU 11.

The RAM 13 is a volatile memory, and forms a work area in which various types of data and programs are temporarily stored. The display unit 14 includes a liquid crystal display (LCD) or an electroluminescent (EL) display, and performs various displays in accordance with display information instructed from the CPU 11.

The storage unit 15 includes a hard disk drive (HDD) or a solid state drive (SSD), and is capable of being written and read with data and a program. Particularly, the storage unit 15 stores various tables to be described later.

The communication unit 16 includes a network card, and communicates with a device on the communication network N in communication connection with the communication network N. The CPU 11 can communicate with the terminal device 20 on the communication network N through the communication unit 16.

A functional configuration of the terminal device 20 will be described with reference to FIG. 3. FIG. 3 is a block diagram of the functional configuration of the terminal device 20.

The terminal device 20 includes a CPU 21, an operation unit 22, a RAM 23, a display unit 24 as a displaying unit, a storage unit 25, a radio communication unit 26, and a timing unit 28. Each of the units in the terminal device 20 is coupled through a bus 29.

The CPU 21, the RAM 23, and the display unit 24 are similar to the CPU 11, the RAM 13, and the display unit 14 in the server 10, respectively, and thus the duplicate descriptions thereof will be omitted and differences will be mainly described.

The CPU 21 controls each of the units in the terminal device 20. The CPU 21 functions as a first display control unit and a second display control unit. The operation unit 22 has a touch panel provided on a display screen of the display unit 24, receives touch input due to the user, and outputs the operation information thereof to the CPU 21.

The storage unit 25 includes a flash memory or an electrically erasable programmable ROM (EEPROM), and is capable of being written and read with data and a program.

The radio communication unit 26 includes an antenna, a transmitting-and-receiving circuit, and a signal processing circuit, and transmits and receives information through a radio wave and the base station on the communication network N. Accordingly, the CPU 21 can communicate with the server 10 through the base station on the communication network N, due to the radio communication unit 26.

The timing unit 28 is a real-time clock, measures the current date and time, and outputs current time information indicating the current date and time, to the CPU 21.

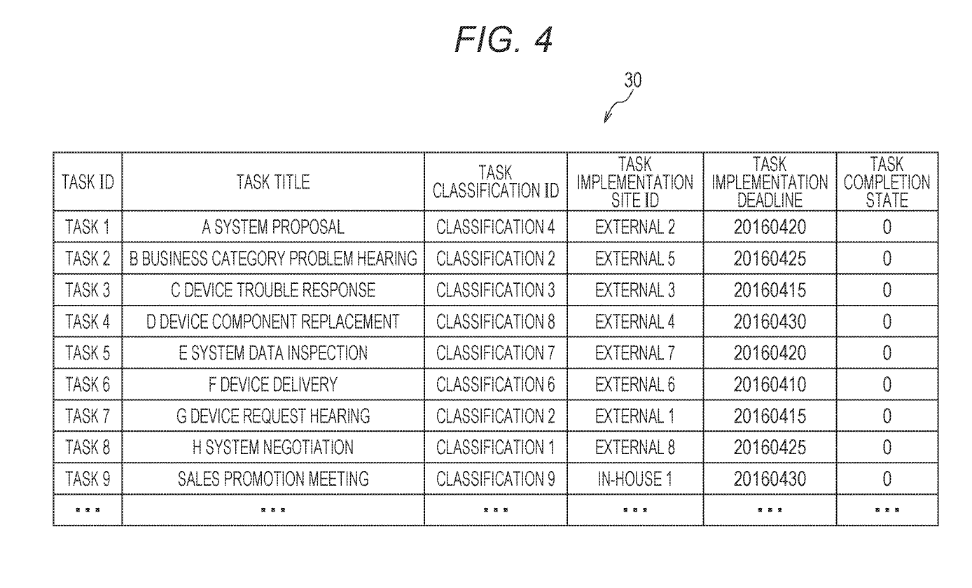

A task table 30 stored in the storage unit 15 in the server 10, will be described with reference to FIG. 4. FIG. 4 is a table of a data structure of the task table 30.

As illustrated in FIG. 4, the task table 30 has items (attributes), such as a “task ID”, a “task title”, a “task classification ID”, a “task implementation site ID”, a “task implementation deadline”, and a “task completion state”, and an entry is created for each task.

The “task ID” includes identifying information on tasks to be implemented by the user.

The “task title” includes titles of the tasks.

The “task classification ID” includes identifying information on task classifications having the tasks classified based on the content of the tasks.

The “task implementation site ID” includes identifying information on sites at which the tasks are implemented.

The “task implementation deadline” includes information on deadlines by which the tasks are required to be completed. According to the present embodiment, the information on the task implementation deadline indicates date and time, but is not limited to this.

The “task completion state” includes flags indicating whether the tasks have been implemented and completed. When each of the tasks has not been completed, the flag is zero. When each of the tasks has been completed, the flag is 1.

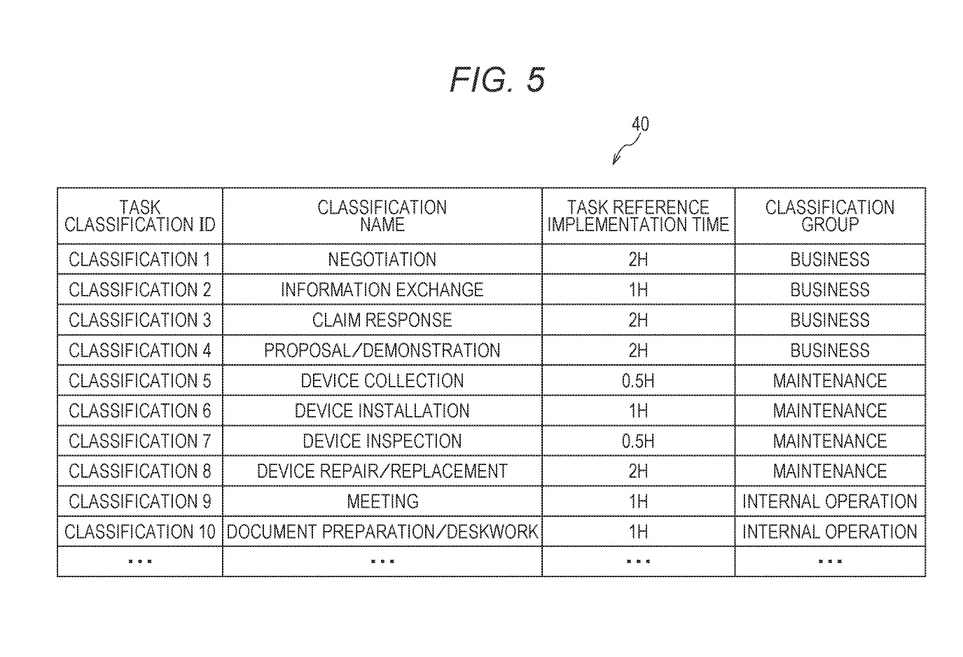

A task classification table 40 stored in the storage unit 15 of the server 10, will be described with reference to FIG. 5. FIG. 5 is a table of a data structure of the task classification table 40.

As illustrated in FIG. 5, the task classification table 40 has items, such as a “task classification ID”, a “classification name”, a “task reference implementation time”, and a “classification group”, and an entry is created for each task classification.

The “task classification ID” is the same as the “task classification ID” in the task table 30 (refer to FIG. 4), and is associated with the “task classification ID” in the task table 30 (refer to FIG. 4).

The “classification name” includes titles of the task classifications. The titles at least include the titles of the tasks to which a superordinate concept has been given.

The “task reference implementation time” includes approximate time (H) estimated to be necessary for implementing and completing each of the tasks classified with the task classifications.

The “classification group” includes group titles in which the plurality of the task classifications can be generally named with specific terms. The group titles at least include the titles of the task classifications to which a superordinate concept has been given. Task classifications having a title of the same classification group, mutually have association high to some extent in terms of the content of tasks. The tasks are collectively implemented during a period being one day so that the implementation efficiency of the tasks can be considered to improve. The “classification group” includes one type of group attribute (attribute information).

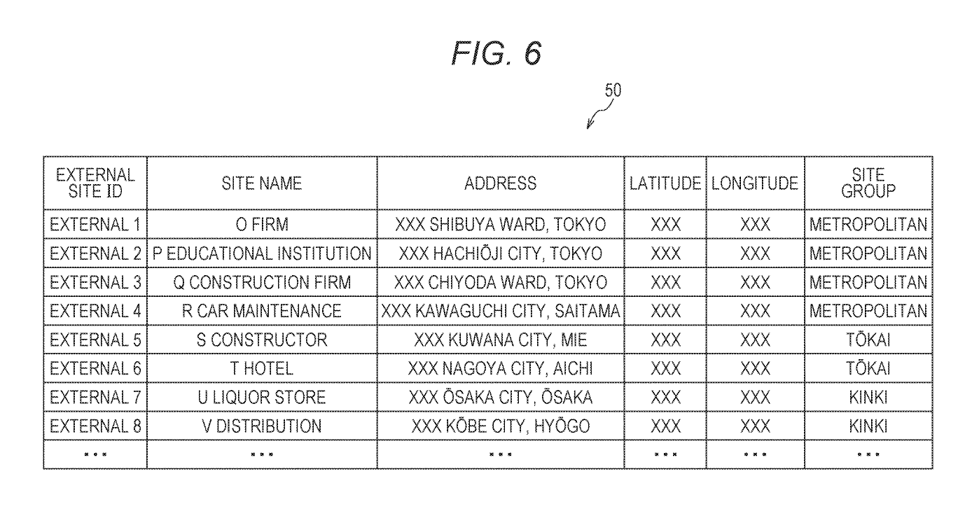

An external site table 50 stored in the storage unit 15 of the server 10, will be described with reference to FIG. 6. FIG. 6 is a table of a data structure of the external site table 50.

As illustrated in FIG. 6, the external site table 50 has items, such as an “external site ID”, a “site name”, an “address”, a “latitude”, a “longitude”, and a “site group”, and an entry is created for each external site.

The “external site ID” includes identifying information on sites at which tasks are to be implemented in the outside, in the task implementation sites identified in the “task implementation site ID” in the task table 30 (refer to FIG. 4).

The “site name” includes names of the task implementation sites.

The “address” includes address information on the task implementation sites.

The “latitude” includes latitude information on the task implementation sites.

The “longitude” includes longitude information on the task implementation sites.

The “site group” includes group titles in which a plurality of the sites can be generally named with specific terms. The group titles at least include addresses of the task implementation sites to which a superordinate concept has been given. External sites, in-house sites (to be described later), and employee addresses (to be described later), having the name of the same site group, are task implementation sites mutually close to each other. Thus, the tasks are collectively performed during a period, such as one day, so that the implementation efficiency of the tasks can be considered to improve. The “site group” for the external sites includes one type of group attribute.

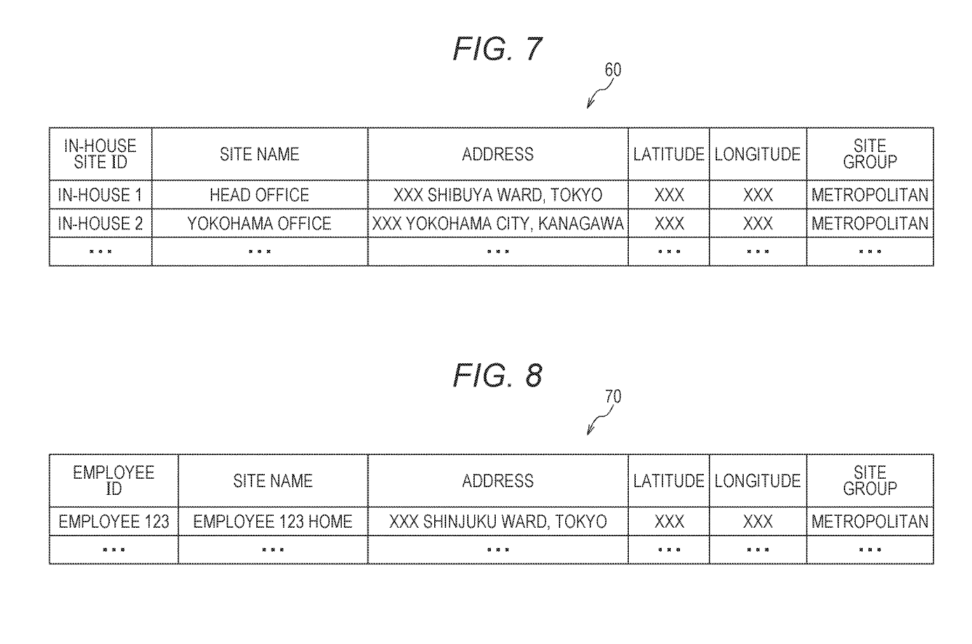

An in-house site table 60 stored in the storage unit 15 of the server 10, will be described with reference to FIG. 7. FIG. 7 is a table of a data structure of the in-house site table 60.

As illustrated in FIG. 7, the in-house site table 60 has items, such as an “in-house site ID”, a “site name”, an “address”, a “latitude”, a “longitude”, and a “site group”, and an entry is created for each in-house site.

The “in-house site ID” includes identifying information on sites at which tasks are to be implemented in the in-house site in the task implementation sites identified in the “task implementation site ID” in the task table 30 (refer to FIG. 4).

The “site name” includes names of the task implementation sites.

The “address” includes address information on the task implementation sites.

The “latitude” includes latitude information on the task implementation sites.

The “longitude” includes longitude information on the task implementation sites.

The “site group” includes group titles in which a plurality of the sites can be generally named with specific terms. The “site group” has a feature the same as that of the “site group” in the external site table 50.

An employee address table 70 stored in the storage unit 15 of the server 10, will be described with reference to FIG. 8. FIG. 8 is a table of a data structure of the employee address table 70.

As illustrated in FIG. 8, the employee address table 70 has items, such as an “employee ID”, a “site name”, an “address”, a “latitude”, a “longitude”, and a “site group”, and an entry is created for each employee (user).

The “employee ID” includes identifying information on employees.

The “site name” includes names of homes of the employees.

The “address” includes address information on the homes of the employees. According to the present embodiment, implementation schedules of a plurality of the tasks that can be implemented in one day, are created (to be described later). The address information on the homes of the employees can be used for sites at which the implementation schedules start.

The “latitude” includes latitude information on the homes of the employees.

The “longitude” includes longitude information on the homes of the employees.

The “site group” includes group titles in which a plurality of the sites can be generally named with specific terms. The “site group” has a feature the same as that of the “site group” in the external site table 50.

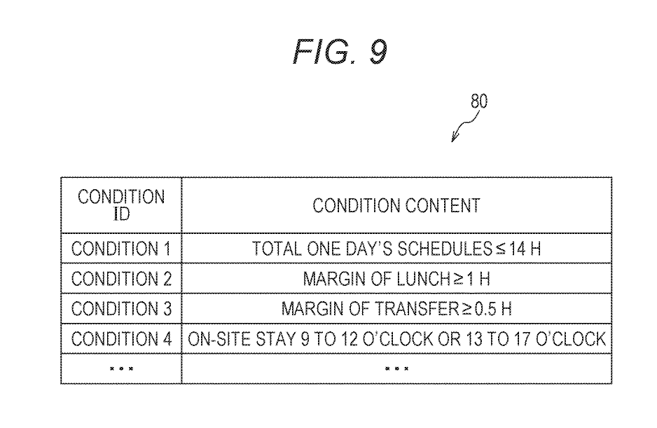

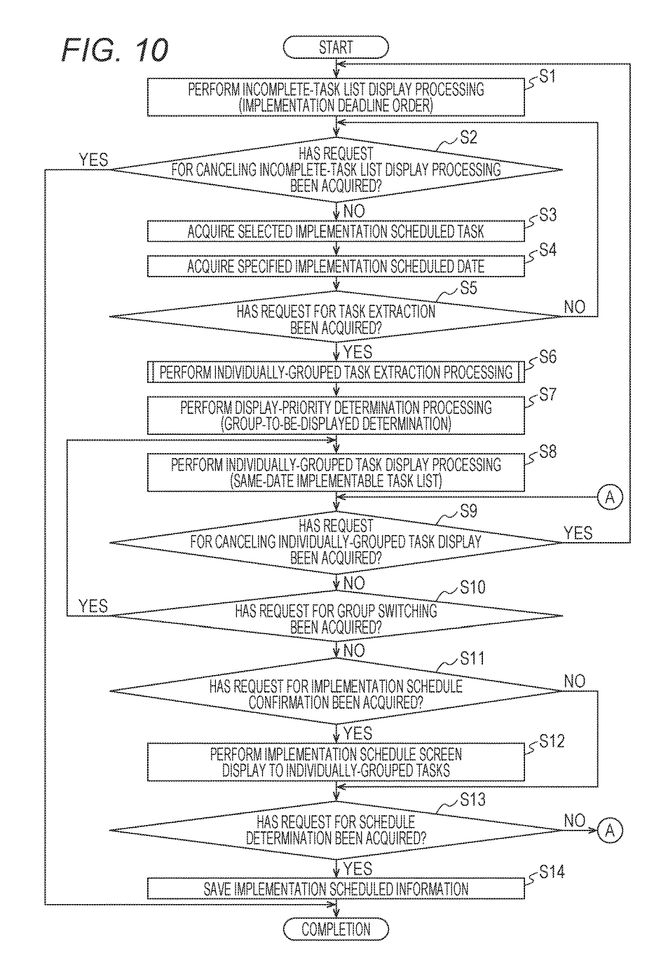

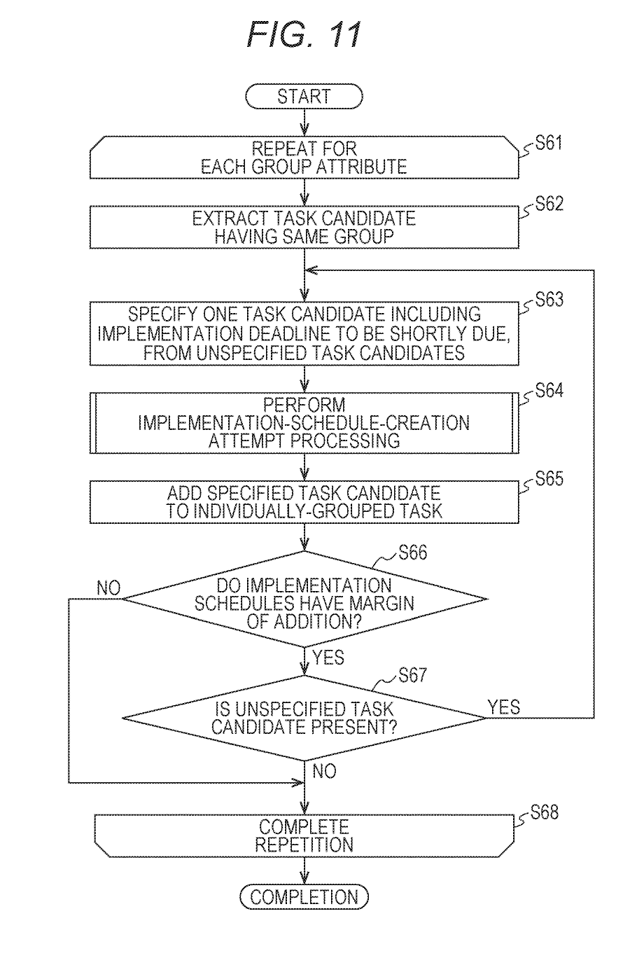

A schedule condition table 80 stored in the storage unit 15 of the server 10, will be described with reference to FIG. 9. FIG. 9 is a table of a data structure of the schedule condition table 80.

As illustrated in FIG. 9, the schedule condition table 80 has items, such as a “condition ID” and a “condition content”, and an entry is created for each schedule condition. The schedule conditions should be satisfied in creating one day's implementation schedules.

The “condition ID” includes identifying information on the schedule conditions.

The “condition content” includes the specific content of the schedule conditions.

For example, “one day′ schedule total≦14 H” (condition 1) in FIG. 9 means that time necessary for completing one or a plurality of the tasks in one day, should be 14 hours or less.

In FIG. 9, “margin of lunch≧1 H” (condition 2) means that a lunchtime of one hour or more (a break) should be provided in the one day's implementation schedules.

In FIG. 9, “margin of transfer≧0.5 H” (condition 3) means that a margin time of at least 30 minutes should be provided for an unforeseen situation in addition to transferring time necessary for transferring to a different task implementation site.

In FIG. 9, “on-site stay 9 to 12 o'clock or 13 to 17 o'clock” (condition 4) means that the implementation time of each of the tasks registered in the task table 30, should be set to be an 9 to 12 o'clock or a 13 to 17 o'clock.

One or a plurality of the schedule conditions can be provided. When the plurality of the schedule conditions is provided, one day's implementation schedules that satisfy the plurality of the schedule conditions, are created (to be described later).

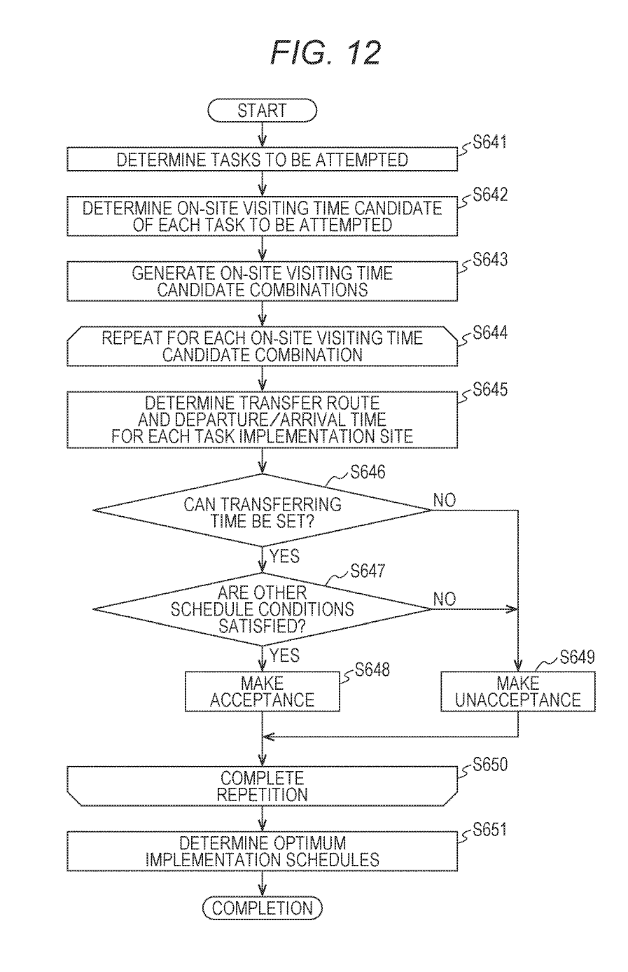

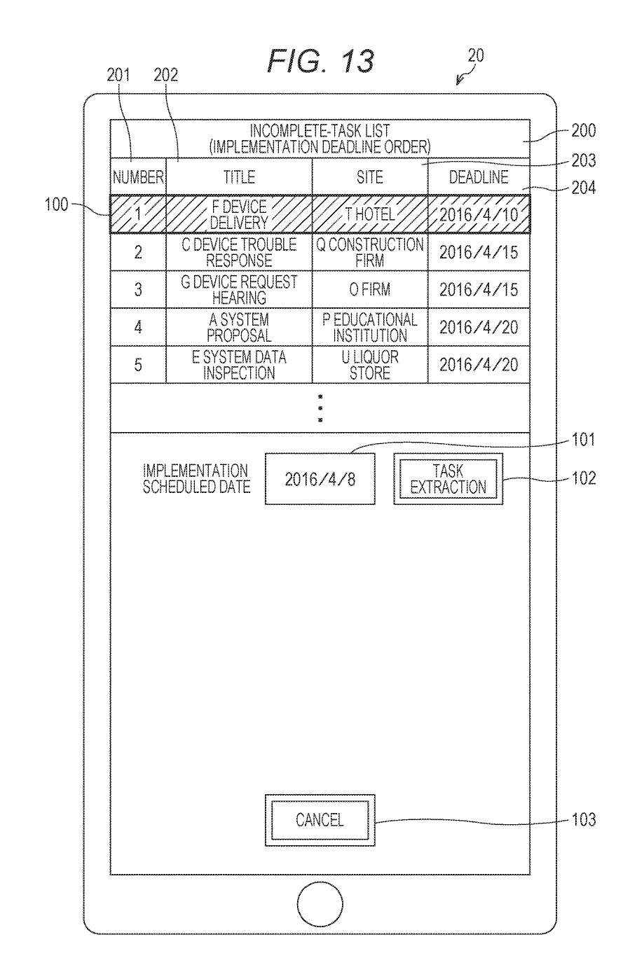

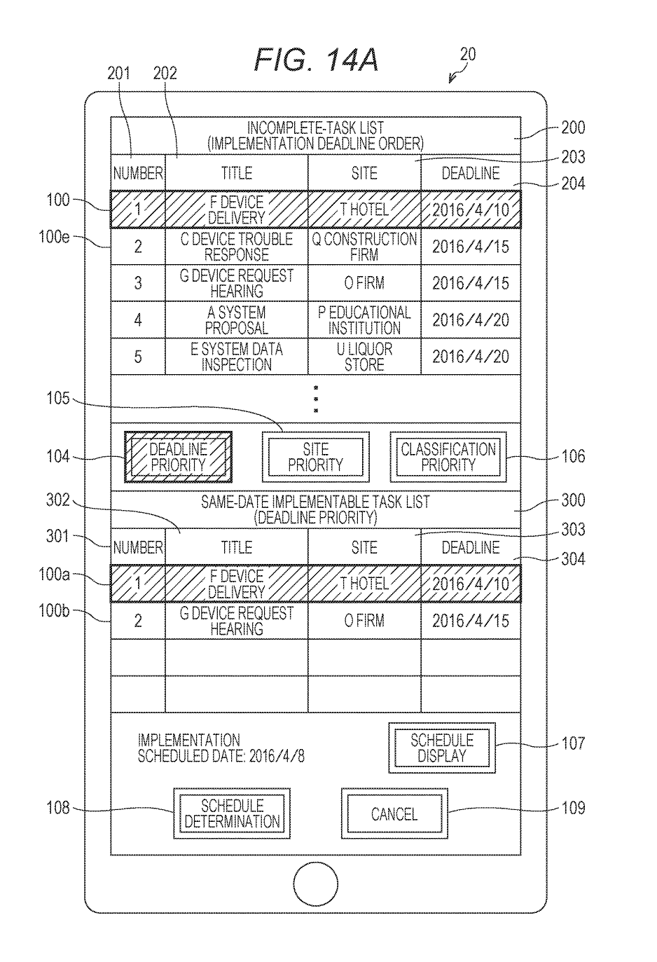

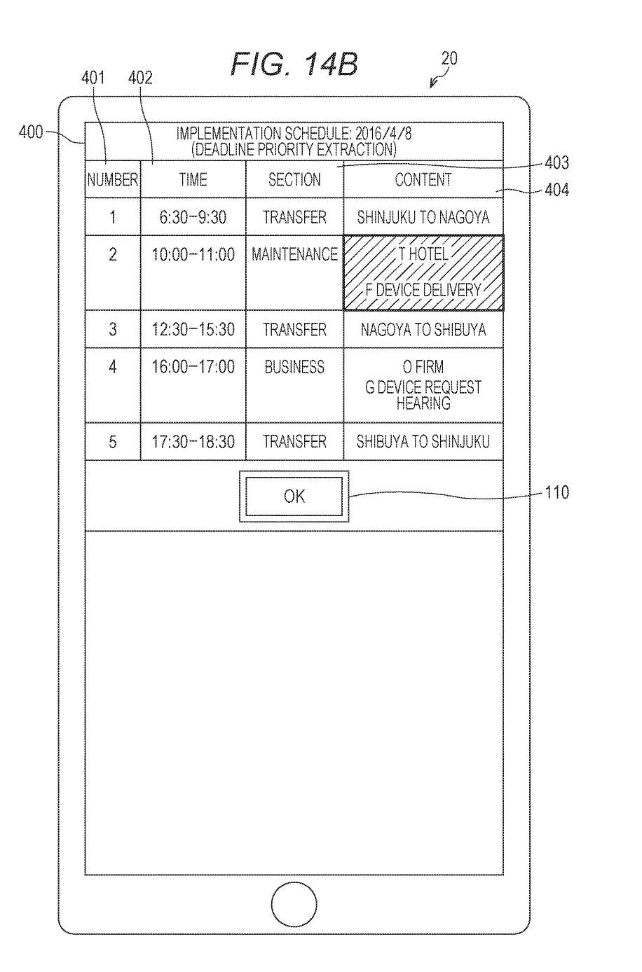

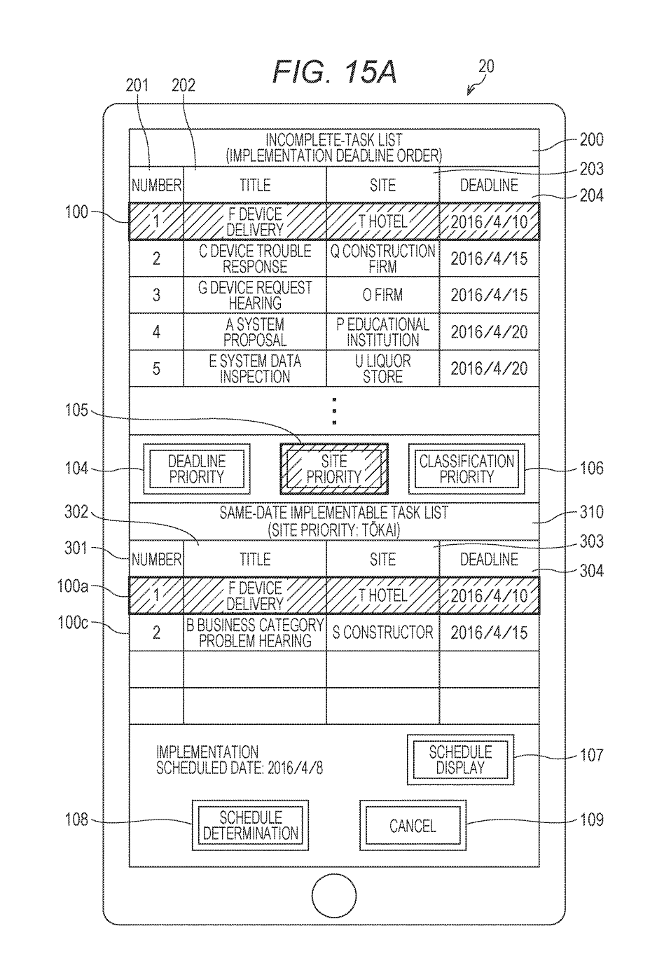

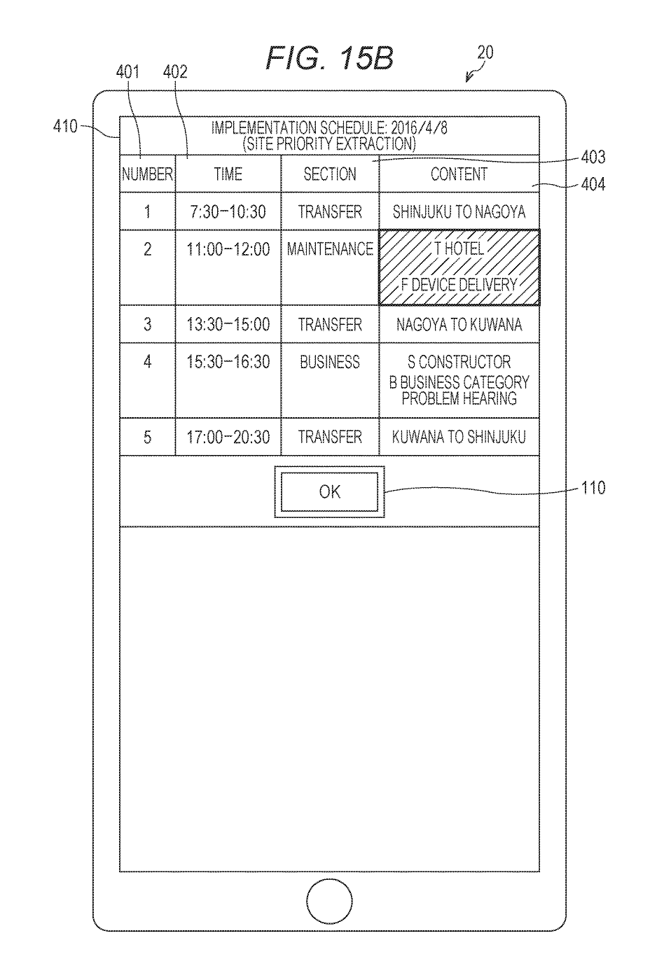

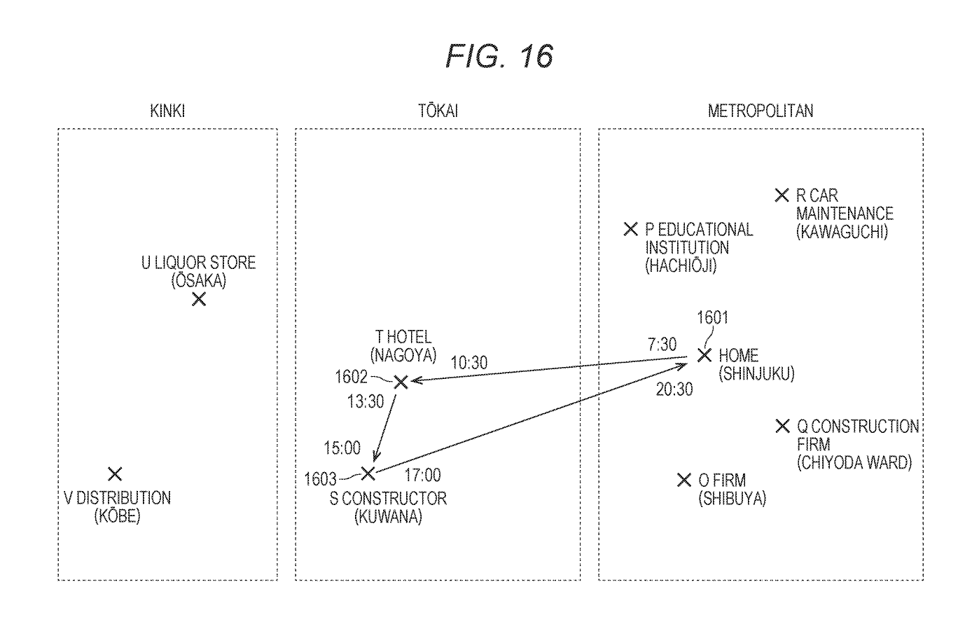

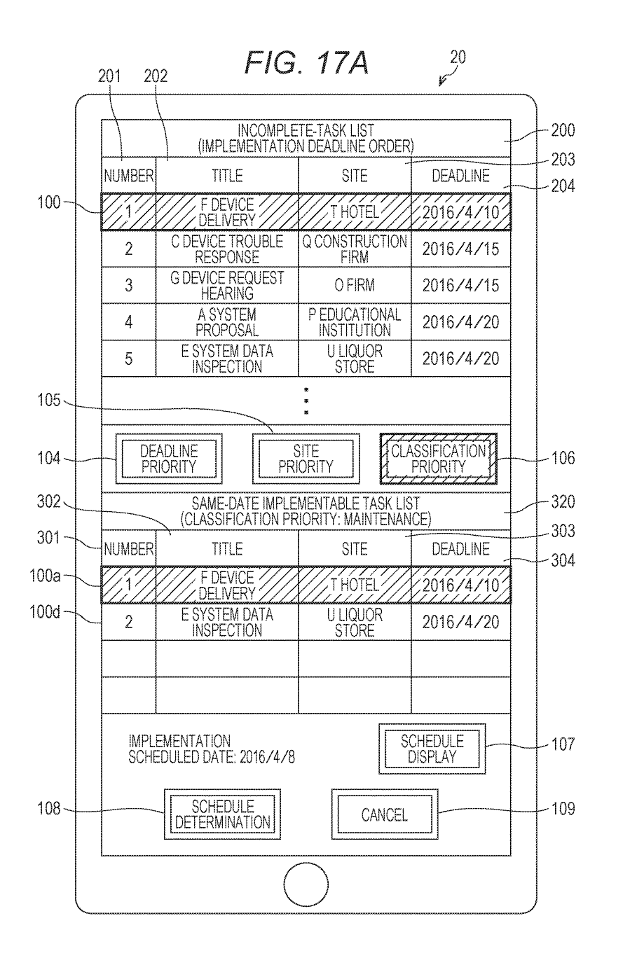

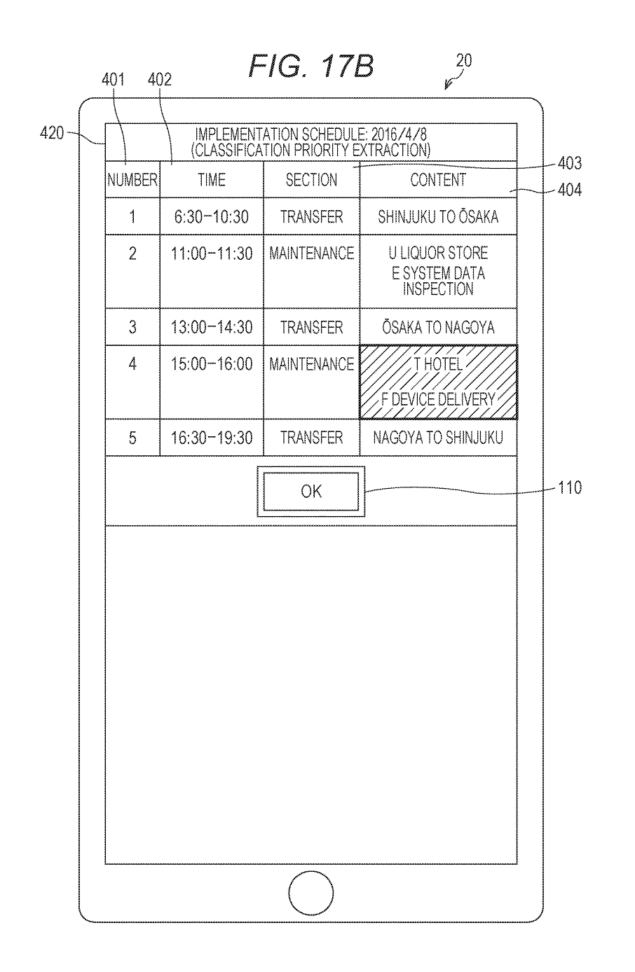

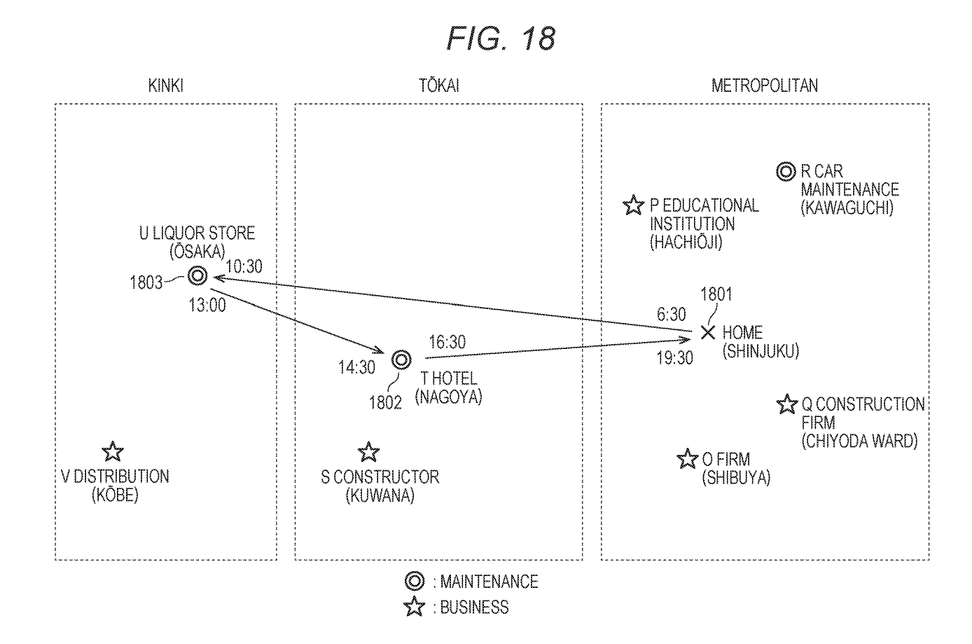

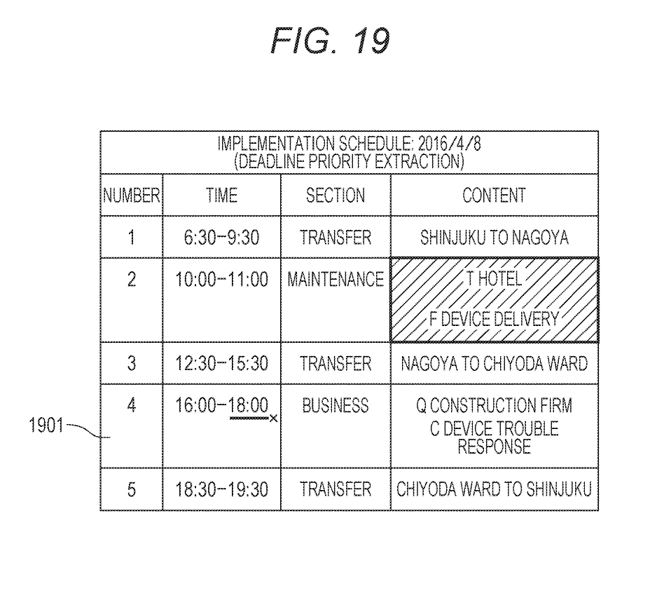

The operation of the task management system 1 will be described with reference to FIGS. 10 to 19. FIG. 10 is a flow chart of implementation scheduled task determination processing. FIG. 11 is a flow chart of individually-grouped task extraction processing. FIG. 12 is a flow chart of implementation-schedule-creation attempt processing. FIG. 13 is a view of an exemplary screen display of a task list. FIG. 14A is a view of an exemplary screen display of an individually-grouped task (deadline priority). FIG. 14B is a view of an exemplary screen display of implementation schedules (deadline priority extraction). FIG. 15A is a view of an exemplary screen display of an individually-grouped task (site priority). FIG. 15B is a view of an exemplary screen display of implementation schedules (site priority extraction). FIG. 16 is an explanatory diagram of a site priority route in the implementation schedules created in accordance with the site priority. FIG. 17 A is a view of exemplary screen display of an individually-grouped task (classification priority). FIG. 17B is a view of an exemplary screen display of implementation schedules (classification priority extraction). FIG. 18 is an explanatory diagram of a classification priority route of the implementation schedules created in accordance with the classification priority. FIG. 19 is a table of exemplary implementation schedules in disagreement with the schedule conditions.

The terminal device 20 previously registers the information on the tasks to be implemented, into the server 10. More specifically, the CPU 21 in the terminal device 20 receives the operation input of task titles, task classifications, task implementation sites, and task implementation deadlines of the tasks to be registered from the user through the operation unit 22. Then, the CPU 21 transmits the information that has been input, to the server 10 through the radio communication unit 26.

After that, the CPU 11 in the server 10 receives the task titles, the task classifications, the task implementation sites, and the task implementation deadlines of the tasks to be registered, from the terminal device 20 through the communication unit 16, so as to register the information into the task table 30 of the storage unit 15. In this case, the CPU 11 generates task IDs of the tasks to be registered, and then adds and registers the task IDs that have been generated, the task titles, the task classifications, the task implementation sites, the task implementation deadlines, that have been received, and 0 (incompletion), as new entries of the task table 30.

The implementation scheduled task determination processing performed by the server 10, will be described with reference to FIG. 10. The implementation scheduled task determination processing makes a list of tasks in a combination that can be implemented efficiently based on a specific task and an implementation scheduled date, specified by the user, so as to determine the tasks as implementation scheduled tasks.

First, the CPU 11 in the server 10 performs incomplete-task list display processing (step S1). Specifically, when acquiring a request for displaying an incomplete-task list from the terminal device 20, the CPU 11 transmits, to the terminal device 20, terminal screen information including task titles, task classifications, task implementation sites, and task implementation deadlines of tasks having a flag of 0 in the task completion state, the tasks being registered in the task table 30. When the terminal device 20 receives the terminal screen information, the display unit 24 can display the incomplete-task list on the screen.

As illustrated in FIG. 13, the terminal device 20 can display, for the incomplete-task list acquired from the server 10, to clarify a number 201 (a consecutive number in the task list), a title 202 (corresponding to the task title), a site 203 (corresponding to the task implementation site), a deadline 204 (corresponding to the task implementation deadline) in an incomplete-task list 200 on the upper side of the screen. Here, the terminal device 20 can arrange and display the incomplete tasks in order of the implementation deadline (ascending order) from the upper side of the screen. However, the arrangement of the task list is not limited to this, and may be the order of the implementation deadline (descending order) or the order of the Japanese syllabary for the titles. Note that, the incomplete-task list 200 includes a list displayed on the screen when the CPU 21 in the terminal device 20 functions as the first display control unit.

Next, the CPU 11 in the server 10 determines whether a request for canceling the incomplete-task list display processing has been acquired from the terminal device 20 (step S2). As illustrated in FIG. 13, the user taps a cancel button 103 through the terminal device 20, the terminal device 20 transmits the request for the cancellation, to the server 10. When the request for canceling the incomplete-task list display processing has been acquired (Yes at step S2), the CPU 11 cancels the incomplete-task list display processing so as to complete the implementation scheduled task determination processing. Then, a predetermined initial screen is displayed on the screen of the terminal device 20.

When the request for canceling the incomplete-task list display processing has not been acquired (No at step S2), the CPU 11 in the server 10 acquires an implementation scheduled task selected through the terminal device 20, from the terminal device 20 (step S3). The user of the terminal device 20 taps and selects a task decided to be implemented, from the task list displayed on the screen of the terminal device 20 (refer to FIG. 13). FIG. 13 illustrates that the first task has been selected and highlighted (reference sign 100). The CPU 11 in the server 10 acquires the task that has been selected, as the implementation scheduled task.

Next, the CPU 11 in the server 10 acquires an implementation scheduled date specified through the terminal device 20, from the terminal device 20 (step S4). As illustrated in FIG. 13, the user of the terminal device 20 inputs the implementation scheduled date of the task that has been selected (2016 Apr. 8) into an implementation-scheduled-date entry field 101. The CPU 11 in the server 10 acquires the implementation scheduled date input into the implementation-scheduled-date entry field 101.

Next, the CPU 11 in the server 10 determines whether a request for task extraction has been acquired from the terminal device 20 (step S5). As illustrated in FIG. 13, when the user taps a task extraction button 102 through the terminal device 20, the request for extracting a task that can be implemented together with the implementation scheduled task that has been selected, at the implementation scheduled date that has been specified, is transmitted from the terminal device 20 to the server 10. When the request for the task extraction has not been acquired (No at step S5), the processing goes back to step S2.

When the request for the task extraction has been acquired (Yes at step S5), the CPU 11 in the server 10 performs individually-grouped task extraction processing with respect to the request for the task extraction, acquired from the terminal device 20 (step S6). The individually-grouped task extraction processing extracts, as a task that can be implemented with respect to the implementation scheduled date, a task (an individually-grouped task) having a specific type of group attribute the same as that of the implementation scheduled task that has been selected. According to the present embodiment, the group attribute includes three types, such as a deadline group, a site group, and a classification group, but is not limited to this, and may include two types or four types or more.

The deadline group includes an attribute relating to the task implementation deadline, and can group tasks having a task implementation deadline set within a specified period from a specified date. The specified date can be the implementation scheduled date input in the implementation-scheduled-date entry field 101 (refer to FIG. 13) or the task implementation deadline of the implementation scheduled task that has been selected, but is not limited to this. The specified period can be a fixed value that has been previously set, and can be one week, for example. In this case, tasks having a task implementation deadline within one week from the specified date, are grouped.

The site group includes an attribute relating to the task implementation site, and can group tasks having, as task implementation sites, sites belonging to a region in which transportation systems or distances from a major city are to some extent common (e.g., the Metropolitan Region, the Mai Region, or the Kinki Region). The site group can be applied to the “site group” in the external site table 50 (refer to FIG. 6), the “site group” in the in-house site table 60 (refer to FIG. 7), and the “site group” in the employee address table 70 (refer to FIG. 8).

The classification group includes an attribute relating to the task classification, and can group tasks belonging to a task classification to which a superordinate concept has been given to some extent (e.g., business, maintenance, or internal operation). The classification group can be applied to the “classification group” in the task classification table 40 (refer to FIG. 5).

The details of the individually-grouped task extraction processing will be described later with reference to FIG. 11. As a result, a task having the same deadline group, a task having the same site group, or a task having the same classification group is individually extracted, as an individually-grouped task, with respect to the implementation scheduled task that has been selected.

Next, the CPU 11 in the server 10 performs display-priority determination processing (step S7). Specifically, the CPU 11 determines, as a task to be preferentially displayed on the screen of the terminal device 20, the individually-grouped task of a group having a maximum number of the tasks, from the individually-grouped task having the same deadline group, the individually-grouped task having the same site group, and the individually-grouped task having the same classification group, extracted by the individually-grouped task extraction processing (step S6). That is, the group including the individually-grouped task having a maximum number of the tasks, is selected as a group to be displayed. When a plurality of the groups including the individually-grouped task having a maximum number of the tasks, is present, an individually-grouped task having an closer implementation deadline, is determined as the task to be preferentially displayed on the screen of the terminal device 20, and a group including the individually-grouped task is the group to be displayed.

Note that, the determination of the group to be displayed, can be one aspect when a classification method in classifying the tasks into the groups, is selected.

Next, the CPU 11 in the server 10 performs individually-grouped task display processing (step S8). Specifically, the CPU 11 transmits terminal screen information including the individually-grouped task classified in the group to be displayed, to the terminal device 20. When the terminal device 20 receives the terminal screen information, the display unit 24 can display, on the screen, the individually-grouped task classified in the group to be displayed, together with the implementation scheduled task that has been selected.

As illustrated in FIG. 14A, the individually-grouped task display processing is performed so that task F information 100a on the implementation scheduled task that has been selected, is displayed in a same-date implementable task list 300 on the lower side of the screen of the terminal device 20. Task G information 100b on the individually-grouped task classified in the deadline group being a group having a maximum number of the tasks, with respect to the task F information 100a, is also preferentially displayed in the same-date implementable task list 300 on the screen. Both of the tasks indicated with the task F information 100a and the task G information 100b, can be implemented in one day being the implementation scheduled date (2016 Apr. 8) specified in consideration of the transferring time (same-date implementable tasks).

Note that, the same-date implementable task list 300 is displayed on the screen when the CPU 21 in the terminal device 20 functions as the second display control unit.

Note that, task C information 100e having a task implementation deadline the same as the task implementation dead line of the task G information 100b (2016 Apr. 15), is not classified in the deadline group and then is not extracted and displayed as the individually-grouped task thereof. The reason will be described later.

A deadline priority button 104 illustrated in FIG. 14A is a group switching button for displaying the individually-grouped task classified in the deadline group, on the screen. When the individually-grouped task classified in the deadline group is first displayed on the screen due to the display-priority determination processing (step S7), the deadline priority button 104 is automatically, actively displayed.

A site priority button 105 illustrated in FIG. 14A is a button for a request for displaying the individually-grouped task classified in the site group on the screen, from the terminal device 20 to the server 10. A classification priority button 106 illustrated in FIG. 14A is a button for a request for displaying the individually-grouped task classified in the classification group on the screen, from the terminal device 20 to the server 10.

Next, the CPU 11 in the server 10 determines whether a request for canceling the individually-grouped task display (processing) has been acquired from the terminal device 20 (step S9). As illustrated in FIG. 14A, when the user taps a cancel button 109 through the terminal device 20, the terminal device 20 transmits the request for the cancellation, to the server 10. When the request for canceling the individually-grouped task display has been acquired (Yes at step S9), the CPU 11 suspends the individually-grouped task display processing and then the processing goes back to step S1. Then, the incomplete-task list display screen (refer to FIG. 13) is displayed on the screen of the terminal device 20.

When the request for canceling the individually-grouped task display has not been acquired (No at step S9), the CPU 11 in the server 10 determines whether a request for group switching has been acquired from the terminal device 20 (step S10). As illustrated in FIG. 14A, the user taps the site priority button 105 or the classification priority button 106 in an unselected state, with the deadline priority button 104 being selected, through the terminal device 20. As a result, the deadline priority button 104 is turned in an unselected state and the button that has been tapped is turned in a selected state. The request for the group switching, being a request for making a switch of the individually-grouped task to be displayed, is transmitted from the terminal device 20 to the server 10. When the request for the group switching has been acquired (Yes at step S10), the processing goes back to step S8 and then the individually-grouped task display processing is performed to a group that has been selected.

Note that, the request for the group switching can be one aspect when the classification method in classifying the tasks into the groups, is selected.

When the request for the group switching has not been acquired (No at step S10), the CPU 11 in the server 10 determines whether a request for implementation schedule confirmation has been acquired from the terminal device 20 (step S11). As illustrated in FIG. 14A, when the user taps a schedule display button 107 through the terminal device 20, a request for displaying implementation schedules with respect to the individually-grouped task being displayed on the screen, is transmitted, as the request for the implementation schedule confirmation, from the terminal device 20 to the server 10.

When the request for the implementation schedule confirmation has been acquired (Yes at step S11), the CPU 11 in the server 10 performs implementation schedule screen display processing to the individually-grouped task (step S12). Specifically, the CPU 11 transmits, to the terminal device 20, terminal screen information on the implementation schedules including a task list classified in the deadline group combined. When the terminal device 20 receives the terminal screen information, the display unit 24 can display the implementation schedules illustrated in FIG. 14B, on the screen. Meanwhile, when the request for the implementation schedule confirmation has not been acquired (No at step S11), step S12 is skipped.

For example, the server 10 can create an implementation schedule 400 illustrated in FIG. 14B in consideration of the transferring time with respect to the task list 300 classified in the deadline group, with the transportation route search system S (refer to FIG. 1). The implementation schedule 400 illustrated in FIG. 14B includes a number 401 (a consecutive number for each schedule), a time 402 (implementation scheduled time for each schedule), a section 403 (an outline for each schedule), and a content 404 (details for each schedule) associated for each schedule, and displays a table including the schedules arranged in order of the implementation scheduled time. The user of the terminal device 20 can confirm the implementation schedule 400 displayed on the screen. When the user taps an OK button 110 in FIG. 14B, the screen in FIG. 14A is displayed again.

Next, the CPU 11 in the server 10 determines whether a request for schedule determination has been acquired from the terminal device 20 (step S13). As illustrated in FIG. 14A, when the user taps a schedule determination button 108 through the terminal device 20, a request for adopting the implementation schedules being displayed is transmitted, as the request for the schedule determination, from the terminal device 20 to the server 10. When the request for the schedule determination has not been acquired (No at step S13), the processing goes back to step S9. Meanwhile, when the request for the schedule determination has been acquired (Yes at step S13), the processing proceeds to step S14.

For example, when the user of the terminal device 20 accepts the task list 300 displayed on the lower side of the terminal screen in FIG. 14A and the implementation schedule 400 corresponding thereto, illustrated in FIG. 14B, the user taps the schedule determination button 108 in FIG. 14A so that schedules in the one day being the implementation scheduled date (2016 Apr. 8) can be determined (corresponding to Yes at step S13). In this case, the CPU 11 in the server 10 acquires tasks to which the schedule determination is made (the task F information 100a on the implementation scheduled task that has been selected and the task G information 100b classified in the deadline group when the deadline priority has been selected, as illustrated in FIG. 14A). Note that, the user of the terminal device 20 taps the cancel button 109 illustrated in FIG. 14A so that the task list 300 and the implementation schedule 400 corresponding thereto can be rejected.

Next, the CPU 11 in the server 10 saves, as implementation scheduled information, the extracted tasks to which the schedule determination has been made, and the implementation schedules corresponding thereto, in the storage unit 15 (step S14). Accordingly, the schedule of the user of the terminal device 20 can be managed on the side of the server 10.

When the site priority button 105 (e.g., FIG. 14A) is tapped (Yes at step S10) as the request for the group switching (step S10), as illustrated in FIG. 15A, the display processing is performed to the individually-grouped task classified in the site group (step S8). Then, the task F information 100a (F device delivery) on the implementation scheduled task that has been selected, and task B information 100c (B business category problem hearing) on an individually-grouped task having a task implementation site of the Tokai Region common to the implementation scheduled task that has been selected, are displayed together in a same-date implementable task list 310 on the lower side of the screen of the terminal device 20. Both of the tasks indicated with the task F information 100a and the task B information 100c, can be implemented in the one day being the implementation scheduled date (2016 Apr. 8) specified in consideration of the transferring time.

When the schedule display button 107 is tapped (Yes at step S11), the CPU 11 transmits, to the terminal device 20, terminal screen information on implementation schedules including a task list classified in the site group combined. When the terminal device 20 receives the terminal screen information, the display unit 24 can display an implementation schedule 410, as illustrated in FIG. 15B, on the screen (step S12). When accepting the implementation schedule 410, the user taps the schedule determination button 108 so that implementation scheduled information corresponding thereto is saved in the storage unit 15 of the server 10 (step S13 and step S14).

FIG. 16 illustrates the site priority route of the implementation schedules created in accordance with the site priority. FIG. 16 illustrates the approximate positional relationship between the task implementation sites of the respective tasks. The site priority route in FIG. 16 is equivalent to a route including the implementation schedules illustrated in FIG. 15B visualized. A home of an employee located at a site 1601 corresponds to the schedule origin and the schedule terminal of the implementation schedules illustrated in FIG. 15B. A T hotel indicated at a site 1602 is the task implementation site of the task F information 100a on the implementation scheduled task that has been selected (refer to FIG. 15A). An S constructor indicated at a site 1603 is the task implementation site of the task B information 100c on a same-date implementable task (refer to FIG. 15A). Corresponding to the time 402 illustrated in the implementation schedules in FIG. 15B, departure times of the sites 1601 to 1603 are indicated at beginnings of arrows coupling the sites 1601 to 1603 in FIG. 16. Arrival times of the sites 1601 to 1603 are indicated at ends of the arrows.

As illustrated in FIG. 16, the task implementation site of the task F information 100a and the task implementation site of the task B information 100c are aggregated in the Tokai Region. Accordingly, the transferring time allocated for the implementation schedules in the one day, can shorten and the implementation efficiency of the tasks can improve with respect to the implementation scheduled task that has been selected.

When the classification priority button 106 is tapped as the request for the group switching (Yes at step S10) (e.g., FIG. 14A), as illustrated in FIG. 17A, the display processing is performed to the individually-grouped task classified in the classification group (step S8). Then, the task F information 100a (the F device delivery) on the implementation scheduled task that has been selected and task E information 100d (E system data inspection) on an individually-grouped task having a task classification of the maintenance common to the implementation scheduled task that has been selected, are displayed together in the same-date implementable task list 310 on the lower side of the screen of the terminal device 20. Both of the tasks indicated with the task F information 100a and the task E information 100d, can be implemented in the one day being the implementation scheduled date (2016 Apr. 8) specified in consideration of the transferring time.

When the schedule display button 107 is tapped (Yes at step S11), the CPU 11 transmits, to the terminal device 20, terminal screen information on implementation schedules including a task list classified in the classification group combined. When the terminal device 20 receives the terminal screen information, the display unit 24 can display an implementation schedule 420, as illustrated in FIG. 17B, on the screen (step S12). When accepting the implementation schedule 420, the user taps the schedule determination button 108 so that implementation scheduled information corresponding thereto is saved in the storage unit 15 of the server 10 (step S13 and step S14).

FIG. 18 illustrates a classification priority route of the implementation schedules created in accordance with the classification priority. FIG. 18 illustrates the approximate positional relationship between the task implementation sites of the respective tasks. The classification priority route in FIG. 18 is equivalent to a route including the implementation schedules illustrated in FIG. 17B visualized. The home of the employee located at a site 1801 corresponds to the schedule origin and the schedule terminal of the implementation schedules illustrated in FIG. 17B. The T hotel indicated at a site 1802 is the task implementation site of the task F information 100a on the implementation scheduled task that has been selected (refer to FIG. 17A). An U liquor store indicated at a site 1803 is the task implementation site of the task E information 100d on a same-date implementable task (refer to FIG. 17A). Corresponding to the time 402 illustrated in the implementation schedules in FIG. 17B, departure times of the sites 1801 to 1803 are indicated at beginnings of arrows coupling the sites 1801 to 1803 in FIG. 18. Arrival times of the sites 1801 to 1803 are indicated at ends of the arrows. In FIG. 18, tasks having a classification corresponding to the “maintenance” are each indicated with a “double circle” and tasks having a classification corresponding to the “business” are each indicated with a “star” (refer to the task classification table 40 in FIG. 5).

As illustrated in FIG. 18, the classification of the task F information 100a and the classification of the task E information 100d, on the tasks to be implemented in the one day, are only the maintenance. Accordingly, a plurality of tasks to be implemented in one day can be made similar to the implementation scheduled task that has been selected so that the implementation efficiency of the tasks can improve.

The individually-grouped task extraction processing performed by the server 10, will be described with reference to FIG. 11. The processing at step S6 in FIG. 10 corresponds to the individually-grouped task extraction processing.

Loop processing in which the individually-grouped task extraction processing starts from step S61 and finishes at step S68 for each of the attributes (the deadline group, the site group, and the classification group in the present embodiment), is performed. According to the present embodiment, the deadline group will be mainly described.

In the present loop processing, the CPU 11 in the server 10 first extracts task candidates having a group the same as that of the implementation scheduled task that has been selected (refer to step S3 in FIG. 10), (step S62). Specifically, the CPU 11 extracts, as task candidates, tasks having a deadline group the same as that of the implementation scheduled task that have been selected, with reference to the task table 30 (refer to FIG. 4). The number of the task candidates to be extracted may be one or at least two.

Next, the CPU 11 in the server 10 specifies one task candidate having a closer implementation deadline, from the task candidates that have not been specified (step S63). Specifically, the CPU 11 specifies, as a task candidate, one task in order of the closest task implementation deadlines, with reference to the task table 30 (refer to FIG. 4). When a plurality of the task candidates having the same task implementation deadline, is present, for example, one is randomly specified.

Next, the CPU 11 in the server 10 performs implementation-schedule-creation attempt processing (step S64). Specifically, the CPU 11 combines the implementation scheduled task that has been selected (refer to step S3 in FIG. 10) and the task candidate specified at step S63, with the transportation route search system S (refer to FIG. 1), so as to create one day's implementation schedules. The details of the implementation-schedule-creation attempt processing will be described later.

Next, the CPU 11 in the server 10 adds the task candidate specified at step S63, to an individually-grouped task, with respect to the implementation schedules created by the implementation-schedule-creation attempt processing (step S65). Specifically, the CPU 11 determines, as tasks to be implemented at the implementation scheduled date specified by the user, the task candidate specified at step S63 together with the implementation scheduled task that has been selected (refer to step S3 in FIG. 10).

Next, the CPU 11 in the server 10 determines whether a margin to which another task is added is present in the implementation schedules that has been created (step S66). Specifically, the CPU 11 determines whether plenty of margin time for incorporating the another task into the implementation schedules that has been created, is present other than the task that has been already scheduled to be implemented (at step S65, the task added to the individually-grouped task together with the implementation scheduled task that has been selected (refer to step S3 in FIG. 10)). The “plenty of margin time” can be set by various methods, and, for example, three hours and fixed margin time can be determined in consideration of the reference implementation time and transferring time of each task. For example, when time at which the tasks that has been already scheduled to be implemented, are completed, is three hours before predetermined termination time in one day (e.g., 17:00), the CPU 11 can determine that the plenty of margin time is present and can determine that a margin to which the another task is added is present (Yes at step S66).

When it is determined that no margin to which the another task is added is present (No at step S66), the CPU 11 in the server 10 completes the creation of the implementation schedules for the deadline group, and creates implementation schedules for another group attribute. When completing the creation of the implementation schedules for all types of the group attributes, the CPU 11 completes the processing in FIG. 11 so that the processing proceeds to step S7 (refer to FIG. 10).

When it is determined that the marge to which the another task is added is present (Yes at step S66), the CPU 11 in the server 10 determines whether a task candidate that has been extracted at step S62 but has not been specified at step S63, is present (step S67). When the task is present (Yes at step S67), the processing goes back to step S63 and the CPU 11 specifies the task candidate implementable during the margin time. Meanwhile, when no task candidate that has not been specified is present (No at step S67), the CPU 11 in the server 10 completes the creation of the implementation schedules for the deadline group and creates the implementation schedules for the another group attribute. When the creation of the implementation schedules for all the types of the group attributes is completed, the processing in FIG. 11 is completed so that the processing proceeds to step S7 (refer to FIG. 10).

When it is determined that the task candidate that has not been specified is present, at step S67 (Yes at step S67), whether new implementation schedules with the task candidate can be created, is attempted (e.g., step S63 and step S64).

The individually-grouped task extraction processing in FIG. 11 can creates implementation schedules including the individually-grouped task to be implemented together with the implementation scheduled task that has been selected combined, for each of the group attributes. The server 10 can manage, as implementation schedules at the implementation scheduled date specified by the user, implementation schedules desired by the user of the terminal device 20 from the implementation schedules created by the implementation schedule-task determination processing in FIG. 10 for the respective group attributes.

The implementation-schedule-creation attempt processing performed by the server 10 will be described with reference to FIG. 12. The processing at step S64 in FIG. 11 corresponds to the implementation-schedule-creation attempt processing.

In the implementation-schedule-creation attempt processing, the CPU 11 in the server 10 first determines tasks to be attempted, to be tasks to which the processing is performed (step S641). The tasks to be attempted, to be determined, include the implementation scheduled task that has been selected, acquired at step S3 in the implementation schedule-task determination processing (refer to FIG. 10), the individually-grouped task that has been added at step S65 in the individually-grouped task extraction processing (refer to FIG. 11), and the task candidate specified at step S63 in the individually-grouped task extraction processing (refer to FIG. 11).

Next, the CPU 11 in the server 10 determines an on-site visiting time candidate for each of the tasks to be attempted, determined at step S641 (step S642). The on-site visiting time candidate is referred to as an arrival time candidate of a task implementation site (a customer) of each of the tasks to be attempted. For example, the on-site visiting time candidate can be set at 0.5 H intervals, and can be set every 0 minutes or every 30 minutes, but is not limited to this.

The on-site visiting time candidate for each of the tasks to be attempted, is determined, for example, based on an on-site stay time condition (corresponding to “condition 4” in the schedule condition table 80 in FIG. 9) and task reference implementation time for each of the tasks to be attempted (corresponding to the task reference implementation time in the task classification table 40 in FIG. 5). With an example of the task (the F device delivery) indicated with the task F information 100a, the on-site stay time condition includes 9 to 12 o'clock or 13 to 17 o'clock (refer to “condition 4” in the schedule condition table 80 in FIG. 9) and the task reference implementation time is 1 H (refer to “classification 6” in the task table 30 in FIG. 4 and in the task classification table 40 in FIG. 5). Therefore, the on-site visiting time candidate for the task (the F device delivery) includes twelve candidates, such as 9:00, 9:30, 10:00, 10:30, 11:00, 13:00, 13:30, 14:00, 14:30, 15:00, 15:30, and 16:00.

Next, the CPU 11 in the server 10 generates an on-site visiting time candidate combination including, as a component, the on-site arrival time candidate of each of the tasks to be attempted (step S643). Specifically, one on-site visiting time candidate is arbitrarily selected for each task to be attempted, from the on-site visiting time candidate of each of the tasks to be attempted, determined at step S642, and then combinations feasibly including, as a component, the one on-site visiting time candidate selected for each task to be attempted, are generated. The number of the combinations is equivalent to the product of the on-site visiting time candidates of the respective tasks to be attempted. Note that, times indicated with the on-site visiting time candidates between the tasks to be attempted, are allowed to overlap, at step S643. That is, times indicated with at least two of the components in the on-site visiting time candidate combination that has been generated, may be the same.

Loop processing that starts from step S644 and finishes at step S650, is performed to all the on-site visiting time candidate combinations generated at step S643.

In the loop processing, the CPU 11 in the server 10 first determines a transferring route, arrival time, and departure time with respect to a task implementation site of each of the tasks to be attempted according to the on-site visiting time candidate combinations (step S645). Specifically, the CPU 11 determines, with the information service in the transportation route search system S (refer to FIG. 1), a transferring route from a schedule origin to a task implementation site, a transferring route between task implementation sites, a transferring route from a task implementation site to a schedule terminal, the departure time of the schedule origin, the arrival time of each of the task implementation sites, the departure time of each of the task implementation sites, and the arrival time of the schedule terminal.

Here, the schedule origin and the schedule terminal can be set to be, for example, a home of an employee (refer to the employee address table 70 in FIG. 8). A transportation system to be used for a transfer of the transferring routes that have been determined, is determined in accordance with an algorithm in the transportation route search system S. On-site stay time is a period from the arrival time of each of the task implementation sites to the departure time of each of the task implementation sites.

Next, the CPU 11 in the server 10 determines whether transferring time necessary for a transfer of each of the transferring routes can be set with respect to the transferring route, the departure time, and the arrival time determined at step S645 (step S646). Specifically, the CPU 11 determines whether the transferring time necessary for the transfer of each of the transferring routes that have been determined, satisfies a transfer margin condition indicated in condition 3 in the schedule condition table 80 (refer to FIG. 9). When the transfer margin condition is satisfied, the transferring time can be set. When the transferring time cannot be set (No at step S645), the on-site visiting time candidate combination to which the loop processing is performed, is rejected because the transfer cannot be made (step S649).

Meanwhile, when the transferring time can be set (Yes at step S645), the CPU 11 in the server 10 determines whether the transferring route, the departure time, and the arrival time determined at step S645 agree with other schedule conditions (step S647). The “other schedule conditions” include all conditions registered in the schedule condition table 80 (refer to FIG. 9) except condition 3 and condition 4. When the other schedule conditions are not satisfied (No at step S647), the on-site visiting time candidate combination to which the loop processing is performed, is unsuitable for implementing the respective tasks to be attempted in one day, and thus is rejected (step S649).

When the other schedule conditions are satisfied (Yes at step S647), the on-site visiting time candidate combination to which the loop processing is performed, is suitable for implementing the respective tasks to be attempted in the one day, and thus is accepted (step S648).

The loop processing including step S644 to step S650, removes an on-site visiting time candidate combination with which a transferring time period cannot be set. For example, an on-site visiting time candidate combination including the on-site stay time entirely or partially overlapping, is removed. Even when the on-site stay time does not overlap, an on-site visiting time candidate combination including the transferring time close as much as the transfer margin condition cannot be satisfied, is removed.

Next, when only one on-site visiting time candidate combination is accepted at step S648, the CPU 11 in the server 10 determines, as optimum implementation schedules, implementation schedules with tasks to be attempted corresponding thereto, with respect to the one on-site visiting time candidate combination. When a plurality of the on-site visiting time candidate combinations is accepted at step S648, the on-site visiting time candidate combinations are narrowed to one in accordance with the following priorities 1 to 4, and the CPU 11 determines, as optimum implementation schedules, implementation schedules with tasks to be attempted corresponding thereto, with respect to the one on-site visiting time candidate combination.

Priority 1: implementation schedules including the termination time of the last on-site stay time, being earliest;

Priority 2: implementation schedules including total time necessary for completing one day's implementation schedules, being shortest (time from the departure time at the schedule origin to the arrival time at the schedule terminal);

Priority 3: implementation schedules including total time necessary for transferring between the schedule origin, each task implementation site, and the schedule terminal, being short;

Priority 4: implementation schedules including the arrival time at each task implementation site, being early.

The priorities 1 to 4 are exemplary, and may be altered. Alternatively, priorities with conditions including the number of transferring trains as a transportation system and the fares, may be used.

The implementation-schedule-creation attempt processing in FIG. 12, can create the provisional implementation schedules. The processing proceeds to step S65 in the individually-grouped task extraction processing (refer to FIG. 11) after the implementation-schedule-creation attempt processing.

When the individually-grouped task extraction processing (refer to FIG. 11) is performed for the deadline group, the task F information 100a on the implementation scheduled task that has been selected (refer to step S3 in FIG. 10) and the task G information 100b being a task candidate, are displayed, as tasks having the same deadline group, in the same-date implementable task list 300 with the deadline priority, indicated on the lower portion of the terminal screen illustrated in FIG. 14A. In this case, a task group to be due within one week from the implementation scheduled date (2016 Apr. 8) specified by the user, belongs to the same deadline group. Therefore, the task G information 100b (task implementation deadline: 20160415) belongs to the same deadline group as the task F information 100a (task implementation deadline: 20160410) on the implementation scheduled task that has been selected. Implementation schedules created by combining the task F information 100a and the task G information 100b agree with the schedule conditions (step S647), there is no margin to which the other tasks are added in terms of the implementation scheduled date (step S66), and the implementation schedule 400 with the deadline priority is created as illustrated in FIG. 14B.

Here, as illustrated in the task table 30 (refer to FIG. 4), with a focus on the task implementation deadline, a “C device-trouble response” (task implementation deadline: 20160415) indicated with the task C information 100e, belongs to the same deadline group as the task F information 100a (task implementation deadline: 20160410) on the implementation scheduled task that has been selected. However, with reference to the task table 30 (refer to FIG. 4) and the task classification table 40 (refer to FIG. 5), the task C information 100e including task classification 3, has a reference implementation time of 2 H so as to require a long time, and thus cannot satisfy all the conditions registered in the schedule condition table 80 (long working hours are unavoidable). Accordingly, implementation schedules created by combining the task F information 100a and the task C information 100e, disagree with the schedule conditions (refer to step S644 in FIG. 12) so that the creation of the implementation schedules is canceled. Therefore, the task indicated with the task C information 100e is not extracted and displayed as the individually-grouped task with the deadline priority, with respect to the task F information 100a on the implementation scheduled task that has been selected.

FIG. 19 exemplifies the implementation schedules in disagreement with the schedule conditions. The implementation schedules illustrated in FIG. 19 correspond to the implementation schedules created by provisionally combining the task F information 100a and the task C information 100e, instead of the implementation schedules illustrated in FIG. 14B. In the implementation schedules illustrated in FIG. 19, the task (C device-trouble response) having a reference implementation time of 2 H, is implemented from 16:00 to 18:00 (refer to reference numeral 1901) so that time at which all one day's tasks are completed is 18:00. However, the implementation schedules do not satisfy condition 4 including the on-site stay time condition set for 9 to 12 o'clock or 13 to 17 o'clock (refer to the schedule condition table 80 in FIG. 9). Therefore, the implementation schedules in FIG. 19 are rejected.

According to the present embodiment, a task that is estimated to be efficiently completed when implemented together with the task that has been selected, can be presented.

Therefore, the user can be notified of the combination of the tasks that can be efficiently implemented.

The user can be notified of the combination of tasks implementable during a predetermined period.

According to the present embodiment, as an individually-grouped task, a task having the same group attribute as the implementation scheduled task selected by the user, is extracted from a large number of the tasks present, by using the various types of the group attributes, and then the task is displayed. The individually-grouped task has any of the task implementation deadline, the task classification, and the task implementation site, similar to that of the task selected by the user, and is estimated to be efficiently completed when implemented together with the task selected by the user.

Therefore, the user can be notified of the combination of the tasks that can be efficiently implemented.

When a plurality of the individually-grouped tasks that has been extracted is present, an individually-grouped task having a closer task implementation deadline, is preferentially extracted (refer to step S63 in FIG. 11) so that a task having a close task implementation deadline can be prevented from being moved down.

In a case where a group attribute indicating the site group is provided, when no task that is the same as the implementation scheduled task selected by the user, is present in the individually-grouped task extraction processing (refer to FIG. 13), the server 10 can extract a task to be implemented at a position (the latitude and the longitude) in a predetermined distance range from the implementation site (the latitude and the longitude) of the implementation scheduled task that has been selected, with reference to the task table 30 (refer to FIG. 4), the external site table 50 (refer to FIG. 6), the in-house site table 60 (refer to FIG. 7), and the employee address table 70 (refer to FIG. 8). The task extracted in this manner is implemented together with the implementation scheduled task that has been selected, so as to be efficiently completed. Even when the function of the site group cannot be utilized, the implementation efficiency of a task group can improve.

An individually-grouped task can be preferentially extracted from a group attribute including more individually-grouped tasks to be extracted with respect to the task that has been selected, in the various types of the group attributes (the deadline group, the site group, and the classification group). Specifically, a group attribute having a larger number of the individually-grouped tasks to be added to one day's implementation schedules, may be accepted. Accordingly, a task group including a number of tasks implementable together, can be prioritized so that the implementation efficiency of the task group can further improve. A group attribute including a larger number of individually-grouped tasks to be implemented by a predetermined deadline, to be extracted, is preferentially accepted so that an individually-grouped task can be extracted. Accordingly, a task group including a number of tasks implementable together can be prioritized in serious consideration of the task implementation deadline so that the implementation efficiency of the task group can further improve.

According to the present embodiment, as an individually-grouped task, a task having the same group attribute as the implementation scheduled task selected by the user, is extracted from a large number of the tasks present, with the various types of the group attributes. In consideration of the reference implementation time of each task, implementation schedules are created over a predetermined period (e.g., one day). Accordingly, the user can easily grasp the order of implementation in a task group including any of the task implementation deadline, the task classification, and the task implementation site, similar.

Therefore, the user can be notified of the combination of the tasks that can be efficiently implemented.

In the descriptions, an example of an HDD or an SSD of the storage unit 15, used as a computer-readable medium storing the program according to the embodiment of the present invention, has been disclosed, but the medium is not limited to the example. Examples of other computer-readable media that can be applied, include a portable recording medium, such as a flash memory and a CD-ROM. As a medium that provides the data of the program according to the embodiment of the present invention through a communication line, a carrier wave is applied to the present embodiment.

(Modification)

The present invention is not limited to the embodiment, and alterations may be made without departing from the spirit of the present invention. Examples of the alterations include the following (a) to (e).

(a): Each task is set with importance, and the server 10 may extract a task with high importance as a task to be implemented together with the task selected by the user in the same day. The server 10 may create implementation schedules including both of the tasks combined in predetermined order.

(b): In creating implementation schedules of a task group to be implemented in the same day (refer to step S64 in FIG. 11), the server 10 may create implementation schedules including a task having a task implementation site further away, to be implemented in an earlier time period. With the implementation schedules, a task to be implemented with a long-distance transfer, is preferentially completed so that a burden accompanied with the transfer of the user between task implementation sites, can be alleviated.

(c): In creating implementation schedules of a task group to be implemented in the same day (refer to step S64 in FIG. 11), the server 10 may create implementation schedules including the implementation scheduled task selected by the user, to be implemented in an earlier time period. With the implementation schedules, the implementation scheduled task selected by the user, is most preferentially completed so that the task to be most preferentially completed can be prevented from not being completed due to the failure of a transportation system.

(d): According to the present embodiment, after the implementation scheduled task is selected (step S3), the selection of the classification method for extracting and displaying a task having the same group as the implementation scheduled task that has been selected, is performed (refer to step S7 and step S10 in FIG. 10), in the implementation schedule-task determination processing (refer to FIG. 10). However, the selection of the classification method may be performed before the implementation scheduled task is selected.

(e): According to the present embodiment, a case where the CPU 11 in the server 10 functions as the task extraction unit and the implementation-schedule-creation unit and the CPU 21 in the terminal device 20 functions as the first display control unit and the second display control unit, has been described. However, the CPU 11 in the server 10 can function as the first display control unit and the second display control unit. The CPU 21 of the terminal device 20 can function as the task extraction unit and the implementation-schedule-creation unit. According to the modification of the present invention, an information processing apparatus partially or entirely including the first display control unit, the second display control unit, the task extraction unit, and the implementation-schedule-creation unit, can be provided.

1. An information processing apparatus comprising:
a first display control unit configured to display a list of tasks associated with attribute information, for each classification method in classifying the tasks into groups, the attribute information corresponding to the classification methods; and
a second display control unit configured to extract and display, from the list, when any task in the list displayed by the first display control unit has been selected and any of the classification methods has been selected, a task having attribute information corresponding to the classification method that has been selected, similar to the attribute information of the task that has been selected.

2. The information processing apparatus according to claim 1,
wherein the second display control unit extracts and displays, from the list, a task estimated to be implementable during a predetermined period with the task that has been selected added.

3. The information processing apparatus according to claim 1,
wherein the list displayed by the first display control unit and the task displayed by the second display control unit are simultaneously displayed.

4. The information processing apparatus according to claim 3,
wherein the first display control unit displays the list on the upper side of a display region and the second display control unit displays the task on the lower side of the display region.

5. The information processing apparatus according to claim 4, further comprising:
a third display control unit configured to display a group selection button provided for each of the classification methods in classifying the tasks into the groups.

6. The information processing apparatus according to claim 5,
wherein the third display control unit displays the group selection buttons at a position between the list displayed by the first display control unit and the task displayed by the second display control unit, in the display region.

7. The information processing apparatus according to claim 4,
wherein the display region is vertically oriented.

8. The information processing apparatus according to claim 6,
wherein the third display control unit horizontally displays the group selection buttons.

9. An information processing apparatus comprising:
a task table including tasks managed with various types of attribute information; and
a processor configured to refer to the task table, when a task to be implemented is selected, and to extract, as an individually-grouped task, a task having a specific type of the attribute information similar to the specific type of the attribute information of the task that has been selected.

10. The information processing apparatus according to claim 9,
wherein the processor preferentially extracts an individually-grouped task having a closer deadline when a plurality of the individually-grouped tasks is extracted for the specific type of the attribute information.

11. The information processing apparatus according to claim 9,
wherein, in a case where the attribute information includes an attribute indicating a site group, the processor extracts, when no task having a site group similar to the site group of the task that has been selected, is present with reference to the task table, a task to be implemented at a site in a predetermined distance range from the implementation site of the task that has been selected.

12. The information processing apparatus according to claim 9,
wherein the processor preferentially uses attribute information including a larger number of the individually-grouped tasks extracted with respect to the task that has been selected or attribute information including a larger number of the individually-grouped tasks to be implemented by a predetermined deadline, extracted, from the various types of the attribute information, so as to extract an individually-grouped task.

13. An information processing apparatus comprising:
a task table including tasks having determined reference implementation time, managed with various types of attribute information; and
a processor configured to refer to the task table, when a task to be implemented is selected, and to extract, as an individually-grouped task, a task having a specific type of the attribute information similar to the specific type of the attribute information of the task that has been selected,
the processor additionally configured to combine, based on the reference implementation time of the individually-grouped task that has been extracted and the reference implementation time of the task that has been selected, at least one of the individually-grouped tasks with the task that has been selected so as to create implementation schedules over a predetermined period.
